(19) United States
(12) Patent Application Publication
(10) Pub. No.: US 2005/0204110 A1
(43) Pub. Date: Sep. 15, 2005

(54) Content move system

(75) Inventors: Kazuhiro Mihara, Moriguchi-shi (JP); Toshikazu Koudo, Nishinomiya-shi (JP); Masaharu Tsujimura, Toyonaka-shi (JP)

Correspondence Address: HAMRE, SCHUMANN, MUELLER & LARSON P.C., P.O. BOX 2902, MINNEAPOLIS, MN, 55402, US

(73) Assignee: Matsushita Electric Industrial Co., Ltd., Kadoma-shi (JP)

(21) Appl. No.: 10/981,133

(22) Filed: Nov. 3, 2004

(30) Foreign Application Priority Data
Nov. 4, 2003 (JP) 2003-374146

(51) Int. Cl. G06F 12/00

(52) U.S. Cl. 711/165; 711/163

(57) ABSTRACT

A content move system including a content-storing apparatus placed on an external bus, thereby performing a content-move operation reliably without losing a portion of the content, is provided. In a content move system for moving a content recorded on a storing part to a recording medium in a content-recording apparatus, a content-sending apparatus having the storing part, a content-recording apparatus, and a content-move controller for controlling the content-move operation conducted by the content-sending apparatus and the content-recording apparatus, are connected onto a 1394 bus. The content-move controller includes a move-source controlling part for managing the operation of the content-sending apparatus and a destination-controlling part for managing the operation of the content-recording apparatus. The content-sending apparatus includes a content-managing part for reading a content to be moved from the storing part and updating the stream information so as to be sent to the 1394 bus, and also a controller-monitoring part for monitoring the operation of the content-move controller.

### BACKGROUND OF THE INVENTION

1. Field of the Invention

The present invention relates to a content move system that can move AV data for which copyright is claimed, from an apparatus in which the data is recorded to another apparatus present on the same bus.

2. Description of Related Art

Due to the current trend for digitized broadcasting, digital AV apparatuses have come into widespread use. Such a digital AV apparatus can realize a high-quality video recording with substantially no degradation, but it allows copying of an AV content without authorization while keeping the high video-image quality. When the unauthorized copies are distributed in the market widely, profits of the copyright holder will suffer a heavy loss. For preventing distribution of such unauthorized copies, measures for limitation of copying the content with the copyright have been practiced.

For preventing distribution of such unauthorized copies, it is possible to inhibit once-recorded data from being recorded again on any other recording media. However, this can force the user to accept inconvenience. For example, when a broadcast is recorded on a hard disk recorder that uses a hard disk as a recording medium, the user must hold the broadcast content in the hard disk or delete the content unless the user can retain the content in an optical disk or tape medium. Therefore, a configuration for recording the content on another recording medium and at the same time deleting the content from the original recording medium, i.e., so-called “move” of content, have been proposed (see, for example, JP 2000-149417 A).

The “move” of content in the conventional configuration indicates that while performing an operation of reproducing a content recorded on a recording medium (first recording medium), the reproduced content is recorded on another recording medium (second recording medium), and at the same time, an already-reproduced portion of the first recording medium is made not to be reproducible again. According to standards such as DTCP (Digital Transmission Content Protection) regarding the copyright protection, at a time of a content-move operation when an AV stream is sent, data of the stream at an already-reproduced portion of an original content shall be updated.

Recently, as media for storing contents such as digital broadcast programs, hard disks often are used. Capacities of the hard disks have gone through remarkable evolution, e.g., it is doubled in size within 2 or 3 years. If a user who once purchases a content move system can use a storage capacity of the same level as a latest model by adding a new hard disk or by exchanging the hard disks alone, the user benefit can be improved. In such a case, the content-storing medium is preferably an apparatus to be connected to an external bus such as IEEE 1394 bus, since the user can carry out the connection work easily, and furthermore, connectable apparatuses can be increased, thereby cost reduction can be expected.

However, there are the following problems in constructing a content move system by placing, on the external bus, a content-storing medium as a source that sends the content to be moved.

As mentioned above, a content-move operation is achieved as a result of complicated exchanges of information among a stream-sending apparatus, a content-recording apparatus and the like. When a plurality of apparatuses are connected onto an external bus so as to move contents, there may occur some accidents, for example, topology configurations of the bus or the components will change, or synchronizations of an operation timing between the content-sending side and the content-recording side will be offset during the content-move operation. When such accidents happen during the content-move operation, a portion of the content in move may be lost or the move operation itself may be suspended irrespective of the user's intention, and thus a stable and reliable content-move operation cannot be performed.

### SUMMARY OF THE INVENTION

In light of the above-described situations, an object of the present invention is to place a content-storing apparatus on an external bus so that a content-move operation can be performed with certainty and without losing a portion of the content.

For achieving the above object, a content move system according to the present invention is a content move system that moves a content recorded on a first recording medium to a second recording medium, wherein a content-sending apparatus for reading the content from the first recording medium, a content-recording apparatus for recording the content on the second recording medium, and a content-move controller for controlling the content-move operation conducted by the content-sending apparatus and the content-recording apparatus are connected onto a same bus, where the content-move controller includes a move-source controlling part for managing the operation of the content-sending apparatus and a destination-controlling part for managing the operation of the content-recording apparatus, where the content-sending apparatus includes a content-managing part for reading a content to be moved from the first recording medium and updating the stream information of the content so as to be sent to the bus, and a controller-monitoring part for monitoring the operation of the content-move controller.

Furthermore, a content-sending apparatus according to the present invention includes a first recording medium for recording a content, where the content is moved to a second recording medium of the content-recording apparatus connected via a bus, wherein the content-sending apparatus is connected via the bus also to a content-move controller that controls the content-move operation, and the content-sending apparatus includes a content-managing part for reading a content to be moved from the first recording medium and updating the stream information of the content so as to be sent to the bus, and a controller-monitoring part for monitoring the operation of the content-move controller.

Accordingly, the present invention can provide a content move system and a content-sending apparatus that can perform a content-move operation stably without a loss in the content.

### BRIEF DESCRIPTION OF THE DRAWINGS

FIG. 1 is a block diagram showing a configuration of a content move system according to a first embodiment of the present invention.

FIG. 2 is a flow chart showing an operation of a move-operation controlling part in the content move system according to the first embodiment.

FIG. 3 is a flow chart showing one example of a controller-monitoring part according to the first embodiment.

FIG. 4 is a flow chart showing another example of a controller-monitoring part according to the first embodiment.

FIG. 5(a) is a block diagram showing a configuration example of the controller-monitoring part according to the first embodiment.

FIG. 5(b) is a flow chart showing an operation of the controller-monitoring part of FIG. 5(a).

FIG. 6(a) is a block diagram showing another configuration example of the controller-monitoring part according to the first embodiment.

FIG. 6(b) is a flow chart showing an operation of the controller-monitoring part of FIG. 6(a).

FIG. 7(a) is a block diagram showing a configuration example of a destination-restricting part according to the first embodiment.

FIG. 7(b) is a flow chart showing a procedure of a process of restricting a destination by the destination restricting-releasing part of FIG. 7(a).

FIG. 7(c) is a flow chart showing a procedure of a process of releasing the destination by the destination restricting-releasing part of FIG. 7(a).

FIG. 8(a) is a block diagram showing another configuration example of a destination-restricting part according to the first embodiment.

FIG. 8(b) is a flow chart showing an operation of a bus-monitoring part of FIG. 8(a).

FIG. 9 is a block diagram showing a configuration of a content move system according to a second embodiment of the present invention.

FIG. 10 is a flow chart showing an operation at a controller-monitoring part according to the second embodiment.

FIG. 11 is a block diagram showing a configuration of a content move system according to a third embodiment of the present invention.

FIG. 12 is a schematic view showing division and move of a content in a conventional content move system.

FIG. 13(a) is a block diagram showing a configuration example of a content-managing part in the third embodiment.

FIG. 13(b) is a schematic view showing division and move of a content by the content-managing part of FIG. 13(a).

FIG. 14 is a schematic view showing one example of division and move of a content by the content-managing part according to the third embodiment.

FIG. 15 is a schematic view showing one example of division and move of a content by the content-managing part according to the third embodiment.

FIG. 16 is a flow chart showing a procedure for managing a reproducible position and a moved position in a case where one content is divided and recorded on plural recording media.

### DETAILED DESCRIPTION OF THE INVENTION

A content move system according to the present invention is a content move system for moving a content recorded on a first recording medium to a second recording medium, wherein a content-sending apparatus for reading a content from the first recording medium, a content-recording apparatus for recording the content on the second recording medium, and a content-move controller for controlling a content-move operation conducted by the content-sending apparatus and the content-recording apparatus are connected onto a same bus; the content-move controller includes a move-source controlling part for managing the operation of the content-sending apparatus and a destination-controlling part for managing the operation of the content-recording apparatus; the content-sending apparatus includes a content-managing part for reading a content to be moved from the first recording medium and updating the stream information of the content so as to be sent to the bus, and a controller-monitoring part for monitoring the operation of the content-move controller (first configuration).

It is preferable in the first configuration that the content-sending apparatus further includes a destination-restricting part that passes a decryption key of the content to only an apparatus designated as a content-recording apparatus, thereby performing a destination-restricting process of restricting the content destination to the content-recording apparatus (second configuration).

It is preferable in the first or second configuration that the move-source controlling part detects an operation state of the content-sending apparatus at the time of the content-move operation, and issues a record-ending request to the destination-controlling part when detecting an abnormality in the operation state; and the destination-controlling part detects an operation state of the content-recording apparatus at the time of the content-move operation, and issues a move-ending request to the move-source controlling part when detecting an abnormality in the operation state (third configuration).

It is preferable in any of the first to third configurations that the controller-monitoring part issues a command for inquiring the operation state of the content-move controller, to the content-move controller (fourth configuration). It is preferable in the fourth configuration that the controller-monitoring part issues the command at a time interval of not longer than one minute (fifth configuration).

It is preferable in any of the first to third configurations that the controller-monitoring part detects the operation state of the content-move controller, on the basis of whether a command access from the content-move controller to the content-sending apparatus is performed at a predetermined cycle (sixth configuration). It is preferable in the sixth configuration that the predetermined cycle is an interval of not longer than one minute (seventh configuration).

It is preferable in any of the first to seventh configurations that the controller-monitoring part includes a command-execution limiting part for executing only a command that agrees with a particular condition, and rejects commands except a command from the content-move controller during the content-move operation (eighth configuration). It is preferable in the eighth configuration that the controller-monitoring part includes an apparatus-list acquiring part for acquiring information about connected apparatuses on the bus when bus initialization occurs during the content-move operation, so that the bus initialization, the controller-monitoring part executes a command only from the content-move controller in a case where the controller-monitoring part confirms that the content-move controller exists on the bus, on the basis of the connected apparatuses information acquired by the apparatus-list acquiring part (ninth configuration).

It is preferable in the second configuration that the content-sending apparatus includes a progress-notifying part for notifying the progress of the destination-restricting process by the destination-restricting part, to the content-move controller (tenth configuration). Alternatively, it is preferable in the second configuration that the content-sending apparatus includes a bus-monitoring part for suspending the content-move operation, in the case where bus initialization occurs continuously after the destination-restricting process by the destination-restricting part is completed (eleventh configuration). It is preferable in the eleventh configuration that the time that the bus initialization-monitoring part requires for suspending the content-move operation from the first bus initialization operation among the continuous bus initialization operations is not longer than one minute (twelfth configuration).

It is preferable in any of the first to twelfth configurations that the content-sending apparatus includes a second destination-controlling part for managing the content-recording apparatus; and when detecting an operation abnormality in the content-move controller during the content-move operation, the controller-monitoring part activates the second destination-controlling part so as to perform the content-move operation continuously (thirteenth configuration).

It is preferable in any of the first to thirteenth configurations that the content-move controller is packaged in a same hardware as the content-recording apparatus (fourteenth configuration).

Another preferable example of a content move system according to the present invention is a content move system for moving a content recorded on a first recording medium to a second recording medium, wherein a content-sending apparatus for reading a content from the first recording medium and a content-recording apparatus for recording the content on the second recording medium are connected onto a same bus; and the content-sending apparatus includes a content-managing part for reading a content to be moved from the first recording medium and updating the stream information of the content so as to be sent to the bus, and a data-broadcast generating part for changing information other than the content sent from the content-managing part into a data-broadcast stream and sending to the bus (fifteenth configuration). It is preferable in the fifteenth configuration that the content-sending apparatus includes a move-state displaying part for displaying a partway state of the content-move by the content-managing part (sixteenth configuration).

Furthermore, another preferable example of a content move system according to the present invention is a content move system for moving a content recorded on a first recording medium to a second recording medium, wherein a content-sending apparatus for reading a content from the first recording medium and a content-recording apparatus for recording the content on the second recording medium are connected onto a same bus; the content-sending apparatus includes a content-managing part for reading a content to be moved from the first recording medium and updating the stream information of the content so as to be sent to the bus; the content-managing part includes a position-managing part for managing a moved position and a reproducible position in the content, and when the move operation is suspended, the content-managing part sets, as a reproducible position, a position dated back toward the head of the content from the moved position for a predetermined time, and resumes the move operation at the reproducible position (seventeenth configuration). It is preferable in the seventeenth configuration that a difference between the moved position and the reproducible position is not longer than one minute in terms of a normal reproduction time (eighteenth configuration).

A content-sending apparatus according to the present invention is a content-sending apparatus that includes a first recording medium for recording a content and moves the content to a second recording medium provided in a content-recording apparatus connected via a bus, wherein the content-sending apparatus is connected via the bus also to a content-move controller for controlling the move operation of the content; and the content-sending apparatus includes a content-managing part for reading a content to be moved from the first recording medium and updating the stream information of the content so as to be sent to the bus, and a controller-monitoring part for monitoring the operation of the content-move controller.

Another preferable example of a content-sending apparatus according to the present invention is a content-sending apparatus that includes a first recording medium for recording a content and moves the content to a second recording medium provided in the content-recording apparatus connected via a bus, wherein
the content-sending apparatus includes a content-managing part for reading a content to be moved from the first recording medium and updating the stream information of the content so as to be sent to the bus, and a data-broadcast generating part for changing information other than the content sent from the content-managing part into a data-broadcast stream and sending to the bus.

Furthermore, another preferable example of a content-sending apparatus according to the present invention is a content-sending apparatus that includes a first recording medium for recording a content and moves the content to a second recording medium provided in a content-recording apparatus connected via a bus, wherein the content-sending apparatus includes a content-managing part for reading a content to be moved from the first recording medium and updating the stream information of the content so as to be sent to the bus; and the content-managing part includes a position-managing part for managing a moved position and a reproducible position in the content, and in a case of suspending the move operation, the content-managing part sets, as a reproducible position, a position dating back toward the head of the content from the moved position for a predetermined time, and resumes the move operation at the reproducible position.

Preferred embodiments of the present invention will be described below more specifically by referring to the attached figures.

### First Embodiment

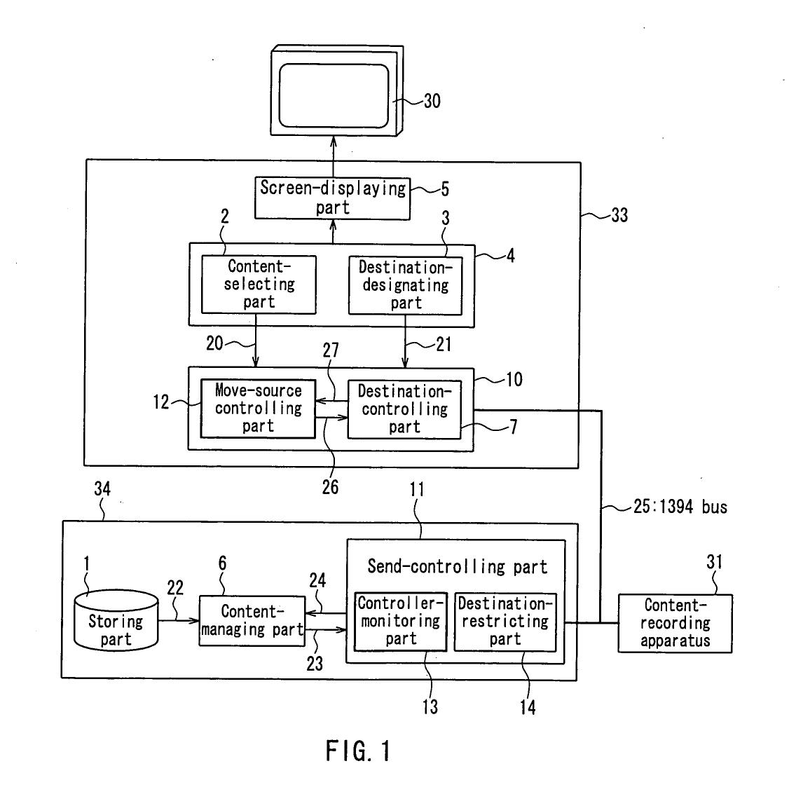

FIG. 1 shows a schematic configuration of a content move system according to a first embodiment of the present invention.

In FIG. 1, numeral 30 denotes a display device such as a CRT, a LCD (liquid crystal display device), or a PDP. Numeral 31 denotes a content-recording apparatus as a destination for a content. The content-recording apparatus 31 is provided, for example, as a D-VHS (Digital Video Home System) recorder, a DVD (Digital Versatile Disc) recorder, or a BD (Blu-ray Disc) recorder. Numeral 34 denotes a content-sending apparatus that stores AV contents and sends a designated content among the stored contents to a designated destination. Numeral 33 denotes a content-move controller that controls a content-move from the content-sending apparatus 34 to the content-recording apparatus 31. The content-move controller 33 is provided, for example, as a STB (Set Top Box) or a DTV (Digital TV). Numeral 25 denotes an IEEE1394 bus (hereinafter, referred to as a 1394 bus). The content-sending apparatus 34, the content-move controller 33 and the content-recording apparatus 31 are connected to each other by the 1394 bus 25.

In this embodiment, the content-move controller 33 controls the content-sending apparatus 34 and the content-recording apparatus 31 so as to move the AV content retained in a storing part 1 from the content-sending apparatus 34 to the content-recording apparatus 31.

The content-sending apparatus 34 includes the storing part 1 in which the AV content is recorded, a content-managing part 6, and a send-controlling part 11. The AV content is a recorded program from a digital broadcast, for example, though it is not limited to this example. For the storing part 1, a hard disc is used typically. The content-managing part 6 manages and moves the AV content, corresponding to a designation from a move-operation designating part 4 of the content-move controller 33. The send-controlling part 11 includes a controller-monitoring part 13 and a destination-restricting part 14. The controller-monitoring part 13 monitors the state of the content-move controller 33.

The destination-restricting part 14 has a function of restricting the destination of the AV content to a designated apparatus alone on the 1394 bus 25. That is, in a case of moving the AV content by using the 1394 bus 25, the AV content flowing onto the 1394 bus 25 is encrypted. Therefore, before starting the move operation, the destination-restricting part 14 provides a decryption key for decoding the encrypted AV content to only a content-recording apparatus 31 designated as a destination by a user. Due to this function, the AV content can be viewed and/or listened to only by the content-recording apparatus 31 that has received the decryption key. Therefore, even if an apparatus other than the content-recording apparatus 31 designated by the user records the data on the 1394 bus 25, the AV content cannot be viewed and/or listened to with the apparatus since the apparatus does not have the decryption key. In this manner, the destination-restricting part 14 restricts the destination of the AV content by restricting an apparatus as an object to pass the decryption key of the content to be moved. Details of the destination-restricting process carried out by the destination-restricting part 14 will be described below.

The content-move controller 33 includes a move-operation designating part 4, a screen-displaying part 5, and a move-operation controlling part 10. The move-operation designating part 4 includes a content-selecting part 2 for selecting a content to be moved, and a destination-designating part 3 for designating the destination of the content. The screen-displaying part 5 displays, on the display device 30, operation at the move-operation designating part 4. The move-operation controlling part 10 includes a destination-controlling part 7 and a move-source controlling part 12. The destination-controlling part 7 controls the content-recording apparatus 31 as a destination for the content, and it also monitors the operation. The move-source controlling part 12 controls the content-sending apparatus 34 as a source of the content, and it also monitors the operation.

In FIG. 1, numeral 26 denotes a destination-stopping request issued from the move-source controlling part 12 to the destination-controlling part 7. Numeral 27 denotes a move-source stopping request issued from the destination-controlling part 7 to the move-source controlling part 12.

Next, an operation of the content move system according to one embodiment of the present invention will be described by referring to FIG. 1 to FIG. 8(b). In this embodiment, the content-move controller 33 moves a content recorded on the storing part 1 of the content-sending apparatus 34 to the content-recording apparatus 31.

In this embodiment, the bus to which these three apparatuses are connected is supposed to be IEEE 1394. This bus is standardized regarding mainly a Physical Layer and a Link Layer, and the standard is called a high-speed serial bus standard IEEE1394-1995. Later in the year of 2000, the standard was modified to IEEE1394a-2000 (hereinafter, referred to as IEEE 1394 bus).

This bus standard has a characteristic function for a plug & play and a multimedia data transmission. Furthermore, this bus can transmit AV data with protecting the copyright.

First, the IEEE1394 bus and the copyright protection will be described briefly.

The IEEE1394 bus allocates a band for transmitting data such as video and audio, and thus it can transmit data while guaranteeing the real-time transmission. This data transmission is called an isochronous data transmission. Examples of the data to be transmitted include a MPEG transport stream and a DV stream.

Transmission of control commands or the like among the apparatuses on the bus can be performed by a method called an asynchronous transmission.

Using this transmission method, a RECORD command, a STOP command, a PLAY command or the like is issued from an apparatus to other apparatuses on the IEEE 1394 bus so as to control the other apparatuses.

AV data use permission information performed on the basis of the IEEE1394 bus include CGMS (Copy Generation Management System) and EMI (Encryption Mode Indicator). CGMS exists inside a transport stream sent from a broadcasting station. CGMS denotes a 2-bit data, and values that the CGMS can take and the meaning are as follows.

That is:

| | |
|---|---|
| CGMS = | 11: CopyNever |
| CGMS = | 10: CopyOneGeneration |
| CGMS = | 00: CopyFree |

CopyNever denotes inhibition of copy, i.e., it permits viewing and/or listening to the AV data only once. CopyOneGeneration denotes permission for copying only one generation, and the copied AV data can be viewed and/or listened to repeatedly. CopyFree denotes that the data can be copied freely. When CGMS is 11, that is, at the time of CopyNever, the AV data can be viewed and/or listened to only once. In other words, the AV data can be viewed and/or listened to only when the AV data are broadcast.

Next, EMI will be described below. CGMS is attached to an AV data in a broadcasting station. A STB (Set Top Box) that receives a broadcast wave sent from the broadcasting station passes the received broadcast to an IEEE 1394 bus.

EMI is generated from the above-mentioned CGMS by the STB. The STB examines CGMS of each AV data sent in one isochronous packet data, and allocates one EMI as a representative value to one isochronous packet data. The EMI is retained at a header portion of the isochronous packet data. CGMS has a value as mentioned below.

That is, CGMS=11 represents that copying is inhibited (CopyNever), CGMS=10 represents that copying is permitted for only one generation (CopyOne Generation), and CGMS=00 represents that copying is permitted (CopyFree). The value of the EMI takes a CGMS value with the most severe limitation in the use permission conditions among the CGMS of AV data existing in one isochronous packet data.

For example, when CGMS of an AV data in one isochronous packet data is 11,10,10, the EMI value becomes 11, which is the most severe limitation. When the CGMS is 10,10,00,00, the EMI value becomes 10, which is the most severe limitation. The EMI value is determined in this manner. The EMI can have the following values: EMI=11 represents copying is inhibited (CopyNever), EMI=10 represents that copying is permitted for only one generation (CopyOneGeneration), and EMI=00 represents that copying is permitted (CopyFree). These values are identical to those of CGMS.

The value of EMI=01 is particular to EMI. This is provided by modifying EMI after recording an AV data of CopyOneGeneration, and it represents that a further copy is not permitted (NoMoreCopy). An explanation about EMI can be summarized as mentioned above.

The next description is about a move operation, i.e., moving an AV content, which has been copyrighted and once recorded on a recording medium such as a hard disc, into another apparatus.

In a case where a stream of EMI=10 is recorded on a video recorder, when reproducing the stream, generally a stream is updated to EMI=01 (NoMoreCopy) and sent. Literally, this stream is an unrecordable stream, and thus the user cannot copy the AV content.

In a Standardization Document for DTCP (Digital Transmission Content Protection) (hereinafter, represented as a DTPC standard), a process of “MOVE” is standardized with respect to a content recorded with this stream of EMI=10. A “MOVE” process enables this CopyNever stream to be moved to other recording media. In this process, when recording and reproducing a stream of EMI=10, the stream is sent again as EMI=10 so that this stream will be recordable, instead of a normal process of reproducing the stream as EMI=01. At the same time, an already-reproduced portion becomes irreproducible.

Such a copyrighted stream is transmitted in an encrypted state on the IEEE1394 bus. Therefore, for recording and transmitting the stream accurately, a decryption key must be exchanged accurately between a stream-sending apparatus and a stream-receiving apparatus (recording apparatus). Without receiving an accurate decryption key from the stream-sending apparatus, the stream-receiving apparatus cannot record and reproduce the stream accurately as a video image.

Details of the remaining processes regarding MOVE will be omitted as they are substantially unrelated to the intention of the description in this embodiment.

The embodiment of the present invention includes the move operation as mentioned above. The next description is about an operation of moving a content in the content move system of this embodiment.

First, a user selects a content to be moved from the content-sending apparatus 34 to the content-recording apparatus 31, by using the content-selecting part 2 provided in the move-operation designating part 4.

At this time, the content-selecting part 2 issues a command to the content-sending apparatus 34 via the 1394 bus 25, and acquires information about which content is recorded on the storing part 1. The content-selecting part 2 displays the acquired information on the display device 30 by means of the screen-displaying part 5. At this time, a command of an asynchronous transmission method, which is used by the content-selecting part 2 for the purpose of acquiring information from the content-sending apparatus 34 about the content, is defined in standardization documents such as “AV/C Digital Interface Command Set General Specification” by 1394 TRADE ASSOCIATION, for example.

The content-selecting part 2 displays a title, video recording time or the like of the content on the display device 30, and the user selects a content to be moved, using a remote controller (not shown) or the like. The selection result notification 20 (see FIG. 1) is conveyed to the move-operation controlling part 10.

FIG. 1 shows an example in which one content-recording apparatus 31 is connected to the 1394 bus 25. It is also possible to connect a plurality of content-recording apparatuses 31 to the 1394 bus 25. The destination-designating part 3 detects which apparatuses are connected onto the 1394 bus 25, and displays the detection result on the display device 30 via the screen-displaying part 5. The user selects which content will be moved to which apparatus, using a remote controller (not shown) or the like. The destination-selecting notification 21 (see FIG. 1) is conveyed to the move-operation controlling part 10. On the basis of the content, the move-operation controlling part 10 controls the content-sending apparatus 34 and the content-recording apparatus 31.

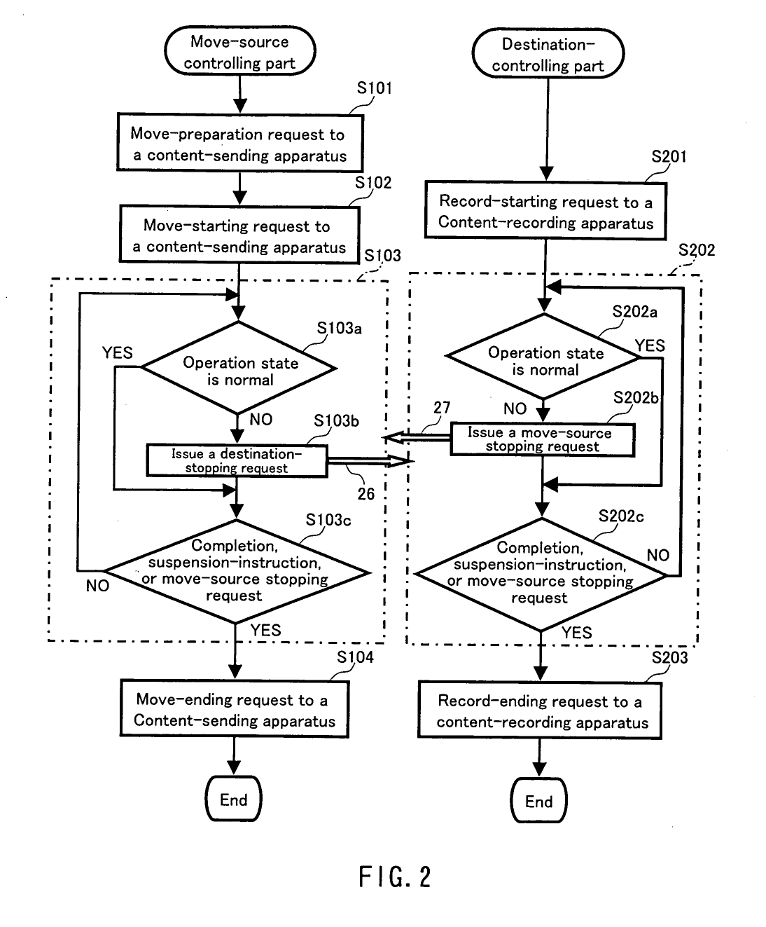

FIG. 2 shows a procedure of controlling the content-sending apparatus 34 and the content-recording apparatus 31 by means of the move-source controlling part 12 and the destination-controlling part 7 of the move-operation controlling part 10. The move-source controlling part 12 controls the content-sending apparatus 34, and the destination-controlling part 7 controls the content-recording apparatus 31.

First, when starting the content-move, steps S101, S102 and S201 in FIG. 2 are executed as procedures for starting the content-move. That is, the move-source controlling part 12 issues a move-preparation request (S101) and a move-starting request (S102) to the content-sending apparatus 34. At substantially the same time, the destination-controlling part 7 issues a record-starting request (S201) to the content-recording apparatus 31. For the order of issuing these requests, an available order is that an issue of the record-starting request (S201) follows the move-preparation request (S101), and subsequently, a move-starting request (S102) is issued further. An alternative order is that an issue of the move-starting request (S102) follows the move-preparation request (S101), and subsequently the record-starting request (S201) is issued.

Particularly, the operation at the move-source controlling part 12 is executed in two stages (S101, S102), since preparation at the content-sending apparatus 34 as the move-source can require a comparatively long time. Before starting sending for a content move from an ordinary stopped state, the content-sending apparatus 34 is required to read out a reproduction content from a storing part 1 and store it in a stream-sending memory (not shown) as a preparation for an ordinary reproduction operation, and also to perform processes such as restriction of the content destination (described later). When starting the video recording operation by the content-recording apparatus 31 without considering the time for the preparation, operation timings between the content-sending apparatus 34 and the content-recording apparatus 31 do not agree with each other, and thus the head portion of the content in move is not recorded, or the stream will not be sent to the content-recording apparatus 31, and thus unrecorded portions will exist for a long time at the head of the recorded portion. For avoiding such problems, as shown in FIG. 2, at the move-operation controlling part 10, the move-source controlling part 12 issues a move-preparation request and a move-starting request separately at the time of starting the recording.

The following processes are performed by the content-managing part 6 of the content-sending apparatus 34 in a period from receiving a move-preparation request to receiving a move-starting request and starting the move operation:
1) temporarily storing the head portion of the move range of the moving content from the storing part 1 on the send-memory (not shown);
2) encrypting the AV data in the send-memory for a move operation;
3) providing an encryption key required for a video recording operation, to the content-recording apparatus 31;
4) activating the controller-monitoring part 13; and
5) starting an operation of reproducing the content.

The respective processes are classified into those executed at the time of receiving a move-preparation request (S101) and those executed at a time of receiving a move-starting request (S102). The timings of executing each of the processes rely on equipment of apparatuses, and it is an arbitrarily modified matter.

When the content-move operation between the content-sending apparatus 34 and the content-recording apparatus 31 continues, the move-source controlling part 12 detects the operation state of the content-sending apparatus 34 (S103), and the destination-controlling part 7 detects (S202) whether the recording state of the content-recording apparatus 31 continues.

At S103, the move-source controlling part 12 issues a move-ending request to the content-sending apparatus 34 (S104), in a case where the content-move operation is completed, where there is a suspension instruction due to the user operation or the like, or where there is a move-source stopping request from the destination-controlling part 7 (YES in S103c). Similarly, the destination-controlling part 7 issues a record-ending request to the content-recording apparatus 31 (S203) in a case where the content-move operation is completed, where there is a suspension instruction due to the user operation or the like, or where there is a destination-stopping request from the move-source controlling part 12 (YES in S202c). The suspension instruction by the user operation or the like will occur, for example, as a result of a user operation or the like at the content-move controller 33.

Furthermore, stopping requests caused by changes in the operation state of the content-sending apparatus 34 and the content-recording apparatus 31, such as “the user suspends the sending-operation of the content-sending apparatus 34” or “at the end of the tape of the content-recording apparatus 31”, will be so-called a crossed process. In other words, when detecting an abnormality occurrence by a detection of the operation state of the content-sending apparatus 34 (S103a), the move-source controlling part 12 issues a destination-stopping request 26 (S103b) to the destination-controlling part 7. When detecting an abnormality occurrence by a detection of the operation state of the content-recording apparatus 31 (S202a), the destination-controlling part 7 issues a move-source stopping request 27 to the move-source controlling part 12 (S202b). Then, when receiving the move-source stopping request 27 from the destination-controlling part 7 (YES in S103c), the move-source controlling part 12 issues a move-ending request to the content-sending apparatus 34 (S104). When receiving the destination-stopping request 26 from the move-source controlling part 12 (YES in S202c), the destination-controlling part 7 issues a record-ending request to the content-recording apparatus 31 (S203). Since the move-operation controlling part 10 of the content-move controller 33 executes such monitoring procedures, the content move system of this embodiment can perform a content-move operation while causing hardly any content loss.

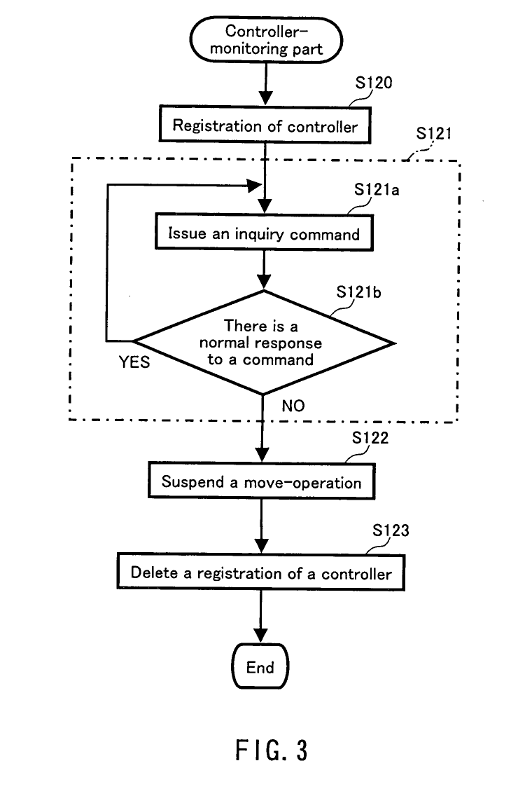

Next, the operations of the controller-monitoring part 13 in the content move system in this embodiment are explained by referring to FIG. 3 to FIG. 6(c). FIG. 3 shows an example of monitoring procedures at the controller-monitoring part 13 in this embodiment.

The controller-monitoring part 13 registers the controller (S120) by using as a trigger the move-preparation request (S101 in FIG. 2) or the move-starting request (S106 in FIG. 2) from the move-source controlling part 12 of the content-move controller 33 to the content-sending apparatus 34. Registration of the controller is performed as mentioned below, for example. After the content-sending apparatus 34 is activated, the controller-monitoring part 13 acquires a node identifier included in the packet of the move-preparation request or the move-starting request, and registers the thus acquired node identifier in the internal memory (not shown).

Subsequently, during the continuous content-move operation, the controller-monitoring part 13 confirms periodically (S121) that the content-move controller 33 as a controller operates normally. In a step S122, the controller-monitoring part 13 issues commands periodically to the content-move controller 33, and confirms that normal responses return (S121a, S121b). For the commands issued at this time, for example, a command for inquiring whether the power source of the content-move controller 33 is in an ON or OFF state is used. An example of the command is described in AV/C Digital Interface Command Set General Specification standardized by 1394 TRADE ASSOCIATION or the like.

When a proper response does not return because the content-move controller 33 is lost on the 1394 bus 25 or because the power source becomes an OFF state, the controller-monitoring part 13 judges that the content-move controller 33 falls in an abnormal state, and issues a suspension instruction (24 in FIG. 1) for the move operation to the content-managing part 6 (S122). Thereby, the content-move operation is terminated. After suspending the move operation, the controller-monitoring part 13 deletes the registration of the controller (S123). Through the above-mentioned procedures, in a case where the content-move operation is not performed normally due to an abnormality in the content-move controller 33, the abnormality can be detected quickly so as to terminate the move operation. Therefore, a loss of the content can be avoided.

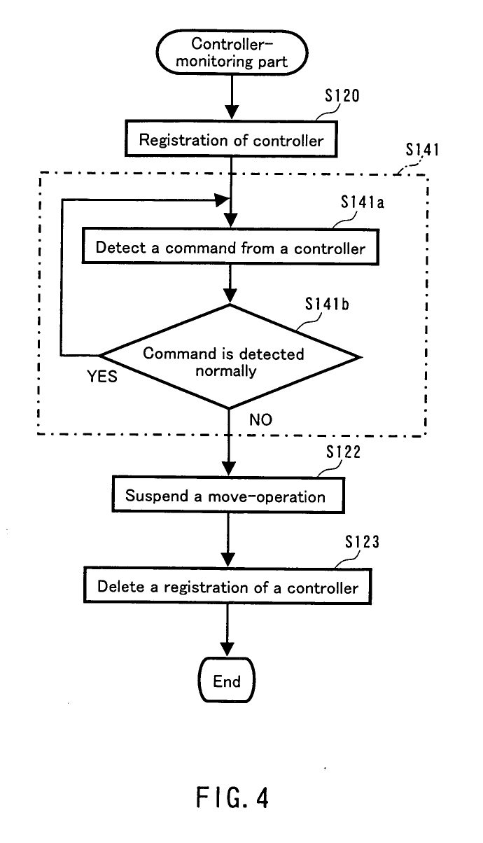

FIG. 4 is a flow chart for showing another example of a monitoring operation procedure of the controller-monitoring part 13 with respect to the content-move controller 33. In FIG. 4, steps for executing the same processes as in FIG. 3 are provided with identical step numbers as in FIG. 3, and the explanations are omitted.

In the procedure in FIG. 3 as described above, for detecting the operation state of the content-move controller 33, the controller-monitoring part 13 issues an inquiry command. On the other hand, in the procedure in FIG. 4, the content-move controller 33 issues commands periodically, and the controller-monitoring part 13 detects the commands so as to detect the operation state of the content-move controller 33.

In the step S141 of FIG. 4, the controller-monitoring part 13 confirms (S141a, S141b) that the state-inquiry from the content-move controller 33 as the controller is performed periodically. And, when there is no inquiry from the content-move controller 33 for a predetermined period, the controller-monitoring part 13 judges that the content-move controller 33 falls in an abnormal state, and issues a suspension instruction (24 in FIG. 1) for the move-operation to the content-managing part 6 (S122). Thereby, when the content-move operation is not performed normally due to an abnormality in the content-move controller 33, the abnormality can be detected quickly so as to terminate the move operation. Therefore, a loss of the content can be avoided.

Meanwhile, in the operation-detecting procedures (S121, S141) shown in FIG. 3 or 4, it is preferable that the operation state of the controller is detected in a cycle of not longer than one minute. The reason is as follows. The DTCP specifications define, regarding the move operation, that the amount of a reproducible content that exists to overlap both in the content-sending apparatus and the content-recording apparatus cannot exceed one minute in terms of an ordinary reproduction time. In other words, a content that has been sent completely from the content-sending apparatus is regarded as not reproducible on the content-sending apparatus, when one minute passes from the sending.

That is, in a case where a trouble can be detected within one minute from the occurrence and the move operation of the content can be suspended immediately, the move operation can be resumed with the portion remaining in the content-sending apparatus in a reproducible state so that the loss of the content can be avoided.

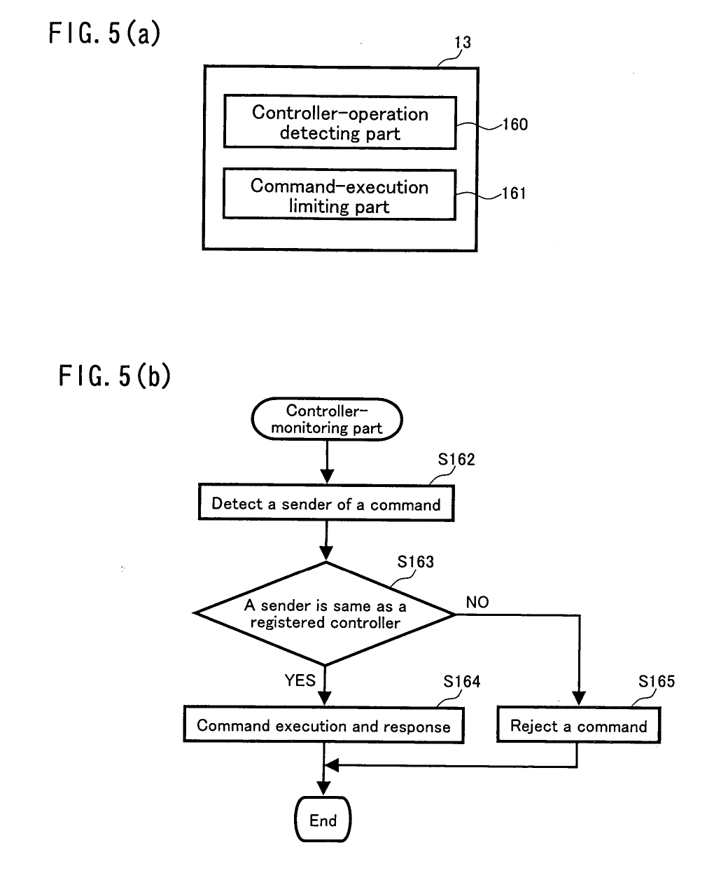

FIG. 5(a) shows another configuration example of the controller-monitoring part 13 according to this embodiment. In the example as shown in FIG. 5(a), the controller-monitoring part 13 has a controller-operation detecting part 160 and a command-execution limiting part 161. The controller-operation detecting part 160 is a portion for executing the processes as shown in FIG. 3 or 4. The command-execution limiting part 161 detects a source of commands sent from other apparatuses on the 1394 bus 25 and permits/limits execution of the commands in accordance with the senders. That is, the command-execution limiting part 161 is a system for preventing the move operation from being suspended by a control command from apparatuses other than the content-move controller 33 during a content-move operation.

FIG. 5(b) is a flow chart showing an operation procedure of the controller-monitoring part 13 configured as shown in FIG. 5(a). In FIG. 5(b), steps for executing the same procedure as in FIG. 3 or 4 are provided with identical step numbers as in FIG. 3 or 4, and the explanations are omitted.

After registration (S120 in FIG. 3) of the controller whose operation state is a subject of detection, when the content-sending apparatus 34 receives any command from the 1394 bus 25 during the content-move operation, the command-execution limiting part 161 of the controller-monitoring part 13 detects (S162), based on a node identifier included in the received command, which apparatus on the 1394 bus 25 is the command sender. Next, the command-execution limiting part 161 judges (S163) whether the command sender is the controller (content-move controller 33) of the move-operation that has been registered in S120. When the command sender is the content-move controller 33, the command-execution limiting part 161 allows the content-managing part 6 or the like to execute processes corresponding to the commands and returns the response (S164). When the command sender is other than the content-move controller 33, the command-execution limiting part 161 does not execute the command but returns a response of refusal (S165). Due to this system, even when a plurality of apparatuses that can be controllers for the content-sending apparatus 34 are connected onto the 1394 bus 25, the content-move operation can be performed stably.

When the controller-operation detecting part 160 of the controller-monitoring part 13 operates according to the operation procedure of FIG. 3, the steps S162-S165 in FIG. 5(b) can be executed parallel to the steps S121 in FIG. 3. On the other hand, when the controller-operation detecting part 160 operates according to the operation procedure of FIG. 4, the steps S162-S165 in FIG. 5(b) can be executed between the steps S120 and S141 in FIG. 4.

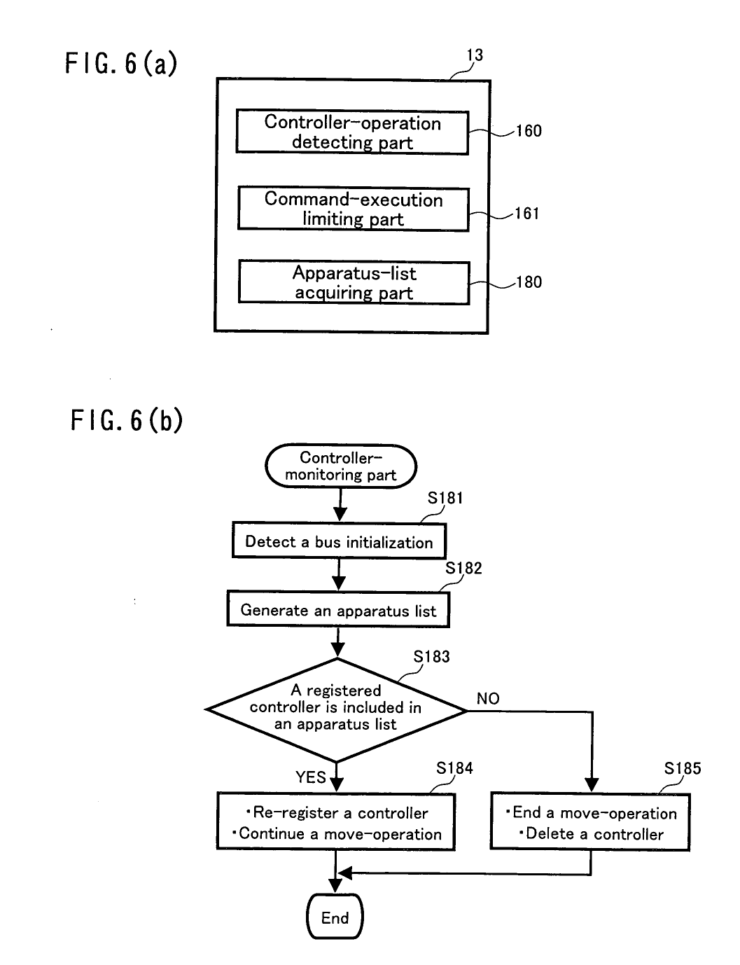

FIG. 6(a) shows a further example in the configuration of the controller-monitoring part 13 according to this embodiment.

According to the example of FIG. 6(a), the controller-monitoring part 13 has the above-mentioned controller-operation detecting part 160 and the command-execution limiting part 161, and further an apparatus-list acquiring part 180. FIG. 6(b) is a flow chart showing the operation procedure of the apparatus-list acquiring part 180. In FIG. 6(b), steps for executing the same procedures as in FIG. 3 or 4 are provided with identical step numbers as in FIG. 3 or 4, and the explanations are omitted.

After registration (S120 of FIG. 3) of the controller whose operation state is subjected to detection, when detecting (S181) occurrence of initialization of the 1394 bus 25 during the content-move operation, the apparatus-list acquiring part 180 issues commands for collecting node information with respect to the respective nodes connected onto the 1394 bus 25. Thereby, the apparatus-list acquiring part 180 acquires a list of apparatuses on the 1394 bus 25 (S182).

When an apparatus identical to the controller (content-move controller 33) registered in the step S120 at the time of starting the move operation exists in the thus acquired apparatus list (YES in S183), the apparatus-list acquiring part 180 regards continuously the apparatus as a controller, and continues the content-move operation (S184).

On the other hand, when an apparatus identical to the controller registered in the step S120 at the time of starting the move operation does not exist in the thus acquired apparatus list (NO in S183), the apparatus-list acquiring part 180 judges that an abnormality has occurred in the controller and suspends the content-move operation and performs an operation of deleting registration of the controller (S185).

As mentioned above, when an initialization (bus reset) of the 1394 bus 25 occurs, an apparatus list on the 1394 bus 25 is acquired, and in a case where the list does not include an apparatus (content-move controller 33) that was registered as a controller at the time of starting the move operation, the content-move operation is ended so as to prevent execution of a content-move operation by an unauthorized controller after the bus reset.

The example shown in FIG. 6(a) is a configuration where the controller-monitoring part 13 includes both the command-execution limiting part 161 and the apparatus-list acquiring part 180. Since the apparatus-list acquiring part 180 operates independently from the command-execution limiting part 161, the command-execution limiting part 161 can be omitted from the configuration.

Next, an operation of a destination-restricting part 14 provided in the send-controlling part 11 of the content-sending apparatus 34 is described below by referring to FIG. 1 and FIG. 7(a) to FIG. 8(b).

The user designates, through the move-operation designating part 4, a content to be moved and also a content-recording apparatus as the destination for the content. Then, the destination-restricting part 14 passes a decryption key of the content to be moved, only to a content-recording apparatus designated by the user through the destination-designating part 3, by means of the procedures as described below. Thereby, a process for restricting the destination of the content to the content-recording apparatus is performed.

After restricting the content destination, the destination-restricting part 14 notifies to the content-managing part 6 (24 in FIG. 1) that the procedure has been completed. The content-managing part 6 that receives the notification starts reproduction of the content in the storing part 1. At the same time, the destination-controlling part 7 makes the content-recording apparatus 31 be a video-recording state. From the storing part 1, reproduction of the recorded contents is started. The numeral 22 in FIG. 1 is an original stream.

The content-move operation performed by the content-managing part 6 includes, as disclosed in JP2000-149417A, an operation of reproducing the content while making an already-reproduced portion unable to be reproduced any more. Standards such as DTCP (Digital Transmission Content Protection) regarding copyright protection define that the stream should be sent while updating the data in the AV stream at the time of a content-move operation. The content-managing part 6 performs the data-updating process in accordance with the standard.

In FIG. 1, numeral 23 denotes a processed stream that has been updated, and it is transmitted on the 1394 bus 25. After the content-managing part 6 starts the move operation, the destination-controlling part 7 continues to monitor as mentioned above to see whether the content-recording apparatus 31 continues a normal video-recording operation. At the same time, the content-managing part 6 disables reproduction of an already-reproduced portion of the AV content. In this manner, a content-move operation is achieved.

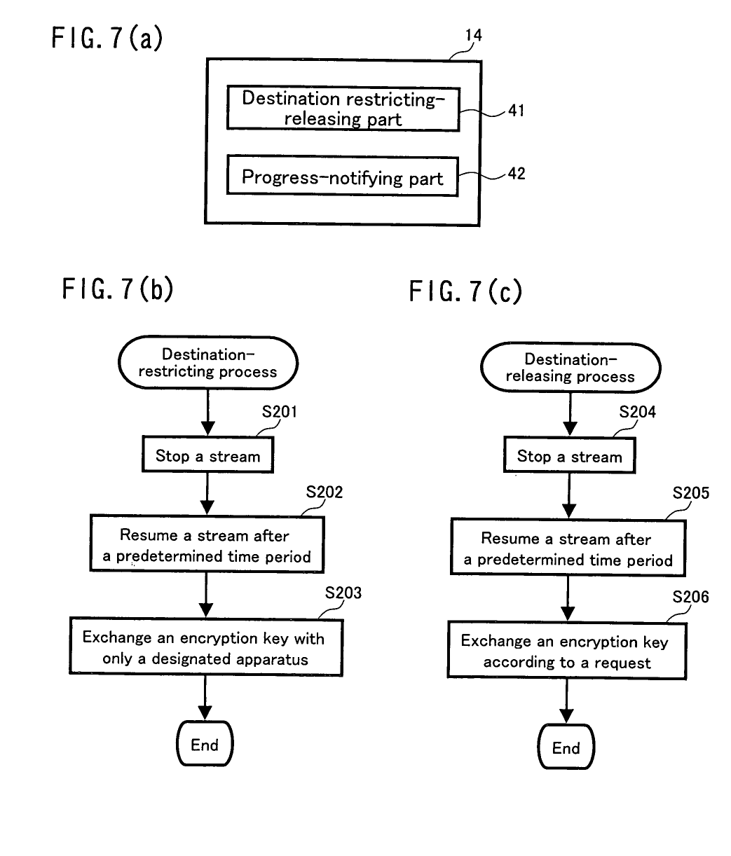

FIG. 7(a) shows an internal configuration of the destination-restricting part 14 in this embodiment. The destination-restricting part 14 includes a destination restricting-releasing part 41 for restricting or releasing a destination of a content, and a progress-notifying part 42 for notifying a progress state of the destination restricting-releasing operation to the content-move controller 33.

First, an operation of the destination restricting-releasing part 41 is described by referring to FIG. 7(b) and FIG. 7(c). FIG. 7(b) is a flow chart for showing a procedure of a process performed by the destination restricting-releasing part 41 of the destination-restricting part 14 for the purpose of restricting a content destination to a particular apparatus in the content move system of this embodiment. The process is performed subsequent to a move-preparation request (S101 in FIG. 2) to the content-sending apparatus 34 and prior to the start of the content-move operation.

As shown in FIG. 7(b), the destination restricting-releasing part 41 of the destination-restricting part 14 halts the stream-sending from the content-sending apparatus 34 (S201). The stream stopped here is not a content stream but a stream including an empty packet alone. After a predetermined time (for example, about one second) from stopping the stream-sending, the destination restricting-releasing part 41 resumes the stream sending (S202). By halting a stream-sending and resuming it after a predetermined time, all of the content-recording apparatuses 31 corresponding to the definition of the DTCP specifications abandon the decryption key they have held until the stopping of the stream, and request a new decryption key with respect to the content-sending apparatus 34. The destination restricting-releasing part 41 provides a decryption key to only a content-recording apparatus 31 designated as a destination by the user (S203). Thereby, only a content-recording apparatus designated as a destination by the user can receive the decryption key from the destination restricting-releasing part 41 and perform recording of the content.

FIG. 7(c) shows a reverse process of the destination-restricting process in FIG. 7(b), that is, the restriction of the content destination is released when a content-move operation is ended. In other words, by halting (S204) and resuming (S205) the stream as in the steps S201 and S202 in FIG. 7(b), the content-recording apparatus 31 on the 1394 bus 25 abandons the decryption key according to the definition of the DTCP specifications. And in this case, the decryption key is provided to all the apparatuses (S206) that request a new decryption key with respect to the content-sending apparatus 34.

As mentioned above, the process of restricting the content destination will take time since there is a need for exchanging information between the content-sending apparatus 34 and the content-recording apparatus 31. Furthermore, for example, there is a high possibility that an abnormality will occur, e.g., the content-recording apparatus 31 fails to request the decryption key. The destination-restricting part 14 in the configuration of FIG. 7(a) includes a progress-notifying part 42 for notifying such states to the content-move controller 33.

Alternatively, notification from the progress-notifying part 42 to the content-move controller 33 can be achieved, for example, by issuing a command for state notification from the content-sending apparatus 34 to the content-move controller 33.

Alternatively, it is possible to execute the destination-restricting process in FIG. 7(b) by the destination restricting-releasing part 41 after the move-preparation request of S101 as shown in FIG. 2, and notify the progress state of the destination-restricting process, as a subsequent response to the move-starting request (S102 in FIG. 2), to the content-move controller 33.

Alternatively, the content-move controller 33 can monitor the progress state of the destination-restricting process by means of a special command. For the command, commands for exclusive use of respective venders, in accordance with AV/C Digital Interface Command Set General Specification or the like standardized by 1394 TRADE ASSOCIATION or the like, can be used.

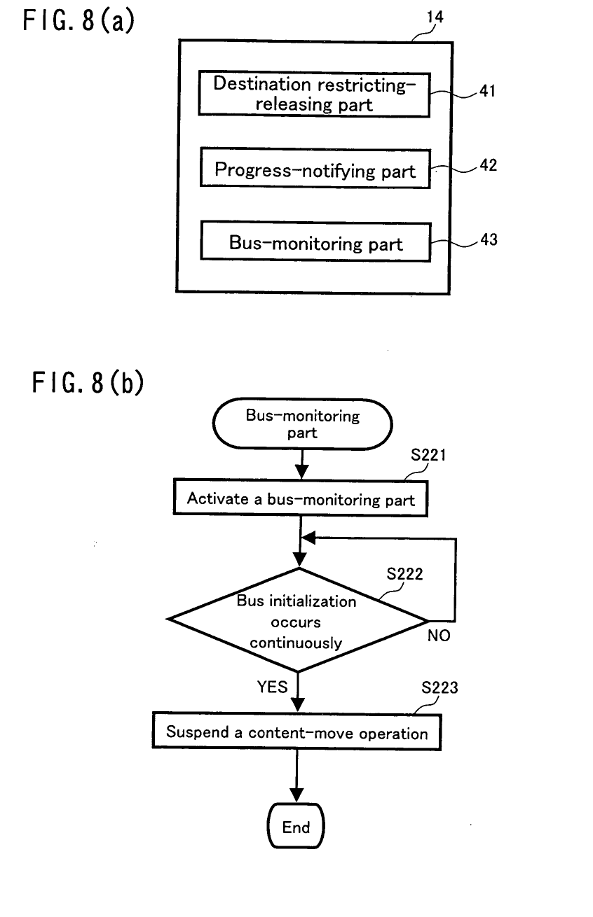

FIG. 8(a) shows another configuration example of the destination-restricting part 14 in this embodiment. In the example shown in FIG. 8(a), the destination-restricting part 14 includes the above-mentioned destination restricting-releasing part 41 and a progress-notifying part 42, and further a bus-monitoring part 43.

FIG. 8(b) is a flow chart showing the operation. The destination-restricting part 14 performing the process of restricting content destination (see FIG. 7(b)) at the time of starting the content-move activates the bus-monitoring part 43 (S221) when the content-move operation starts, thereby detecting the bus initialization.

When a bus initialization occurs, the bus-monitoring part 43 monitors a time period from the first bus initialization. In a case where the bus initialization is concluded within a predetermined time period (NO in S222), the bus-monitoring part 43 detects continuously the occurrence of bus initialization. When new bus initialization occurs continuously within a predetermined time before the first bus initialization is completed and when it is not concluded (YES in S222), the bus-monitoring part 43 issues to the content-managing part 6 a request for terminating the content-move operation (S223). The above-mentioned “predetermined time” is preferably not less than 10 seconds and less than 60 seconds. For accurately checking whether the bus initialization is concluded or not, at least about 10 seconds are required. Regarding the move operation, the DTCP specifications define the upper limit that a reproducible content is allowed to overlap both in the content-sending apparatus and the content-recording apparatus is one minute.

It is defined that, when a bus initialization occurs, the 1394 bus 25 sends a stream continuously for a predetermined time (one second). When bus initialization occurs continuously within this one second, the content-sending apparatus 34 will send the stream continuously.

At that time, if a content-recording apparatus that is not designated as a destination for the content acquires a decryption key from the content-sending apparatus 34 for the purpose of recording, there is a risk that the stream is provided to two content-recording apparatuses.

The bus-monitoring part 43 is not required if the destination-restricting part 14 passes the decryption key to only one object. However, in the case where there is a risk that it can pass the decryption key to plural objects during the occurrence of the bus initialization, the bus-monitoring part 43 must be provided to improve the safety of the move operation.

In the configuration example shown in this embodiment, the content-move controller 33 and the content-recording apparatus 31 are connected as separate hardware to the 1394 bus 25. Alternatively, the content-move controller 33 and the content-recording apparatus 31 can be included in a single hardware.

### Second Embodiment

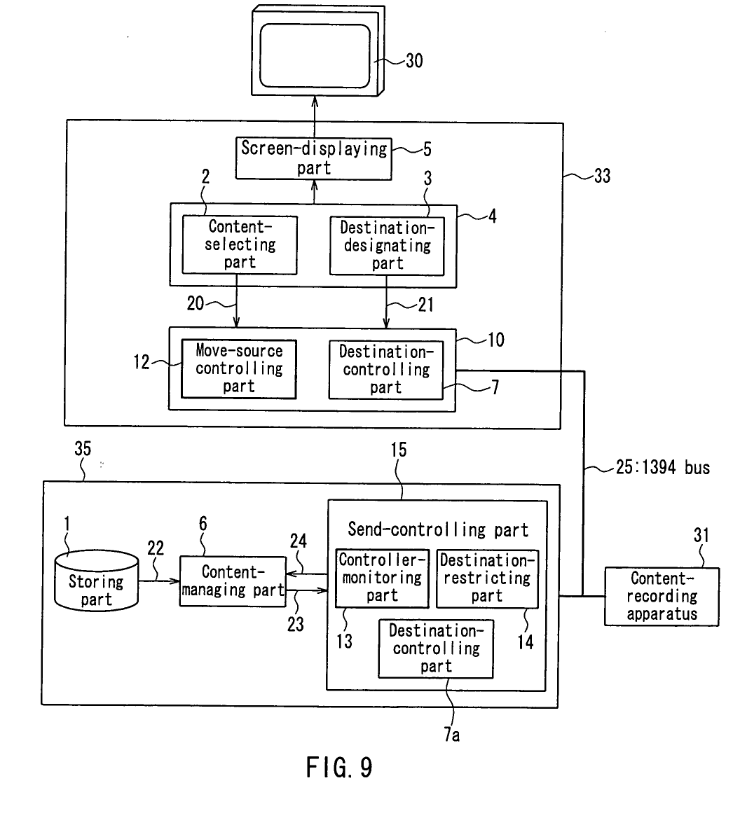

FIG. 9 shows a second embodiment of the present invention. Components having the same functions as the components described in the first embodiment are marked with identical numbers, and explanations for the components will be omitted. The content move system according to this embodiment includes a content-sending apparatus 35 in place of the content-sending apparatus 34 of the content move system according to the first embodiment.

The content-sending apparatus 35 includes a storing part 1, a content-managing part 6, and a send-controlling part 15. The send-controlling part 15 has a controller-monitoring part 13, a destination-restricting part 14, and further a destination-controlling part 7a. The destination-controlling part 7a has the same function as the destination-controlling part 7 of the move-operation controlling part 10 of the content-move controller 33, and it functions on behalf of the destination-controlling part 7 in a case where an abnormality occurs in the content-move controller 33.

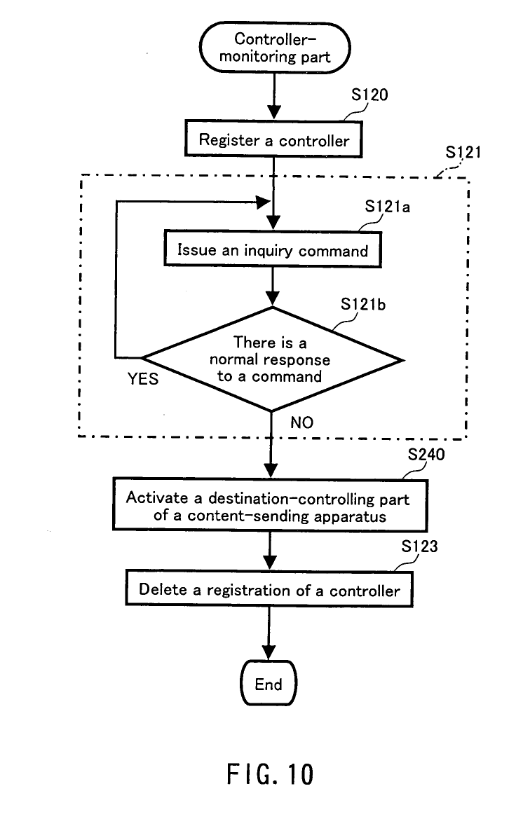

FIG. 10 is a flow chart showing a procedure of processes of the controller-monitoring part 13 in this embodiment. The same processes as those shown in FIG. 3 or the like are marked with the identical step numbers, and the explanations are omitted. The controller-monitoring part 13 registers the controller (S120) when there is a move-preparation request or a move-starting request for the content from the content-move controller 33 as the controller. The controller-monitoring part 13 detects periodically the operation of the content-move controller 33 as the controller after the registration so as to monitor the state (S121). Here, in place of the step S121, the step S141 shown in FIG. 4 can be executed. When detecting an abnormality in the content-move controller 33, the controller-monitoring part 13 activates the destination-controlling part 7a provided to the send-controlling part 15 of the content-sending apparatus 35 (S240). As a result, the destination-controlling part 7a provided in the send-controlling part 15 can monitor the state of the content destination, in place of the content-move controller 33. Thereby, for example, even if the content-move controller 33 is switched off in the halfway of the move operation, the content-move operation can be continued stably. When ending the content-move operation, registration of the controller is deleted (S123).

As mentioned above, according to this embodiment, in a case where an abnormality occurs in the content-move controller 33, the destination-controlling part 7a provided to the content-sending apparatus 35 functions for the destination-controlling part 7 of the content-move controller 33 so that the content-move operation can be continued stably.

### Third Embodiment

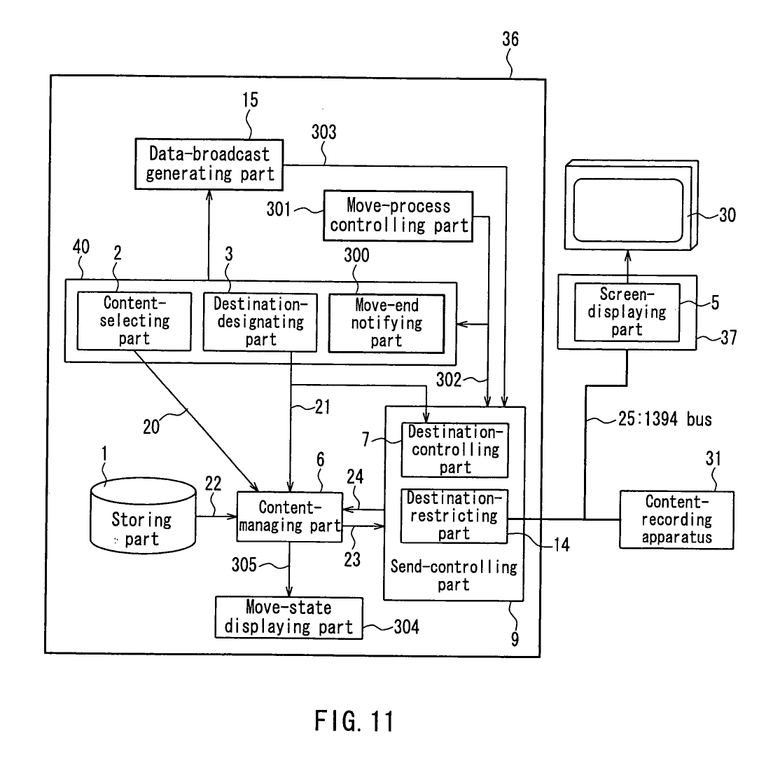

FIG. 11 shows a third embodiment of the present invention. Components having the same functions as the components described in each of the above-mentioned embodiments are marked with identical numbers, and explanations for the components will be omitted. As shown in FIG. 11, a content move system of this embodiment includes a display device 30, a content-recording apparatus 31, a content-sending apparatus 36, and a content display device 37. For the content display device 37, for example, a receiver (tuner) or the like for BS digital broadcast can be used. The content display device 37 is connected to an input terminal of the display device 30. The content display device 37, the content-recording apparatus 31 and the content-sending apparatus 36 are interconnected via the 1394 bus 25.

The content-sending apparatus 36 includes a storing part 1, a content-managing part 6, a send-controlling part 9, a user-interface part 40, a data-broadcast generating part 15, and a move-process controlling part 301. In the content display device 37, numeral 5 denotes a screen-displaying part. The user-interface part 40 in the figure includes a content-selecting part 2, a destination-designating part 3, and a move-end notifying part 300. The send-controlling part 9 in the figure includes a destination-controlling part 7 and a destination-restricting part 14.

In this embodiment, the content-sending apparatus 36 controls the content display device 37 and the content-recording apparatus 31 so as to record AV contents retained in the storing part 1 onto the content-recording apparatus 31.

Operations of the respective parts are described below by referring to FIG. 11.

In the content move system according to this embodiment, first, the move-process controlling part 301 manages the entire sequence for the move. The move sequence is performed in the following steps. First, a selection screen of a content to be moved and a selection screen of a content destination are displayed on the display device 30, so that the content to be moved and the content destination are designated by the user. Next, a content designated by the user is reproduced from the storing part 1, and moved to the content-recording apparatus 31. When the move is completed, the display returns to the previous selection screen. For carrying out the above sequence, the respective components operate in the following manner.

The move-process controlling part 301 notifies a process instruction 302 to the user-interface part 40, thereby activating the content-selecting part 2. A screen for operation (for content selection) generated by the content-selecting part 2 is sent to the data-broadcast generating part 15. Receiving this, the data-broadcast generating part 15 generates a screen for operation, converts it into a data-broadcast stream 303 and outputs. The send-controlling part 9 receiving the data-broadcast stream 303 sends the data-broadcast stream 303 to the 1394 bus 25. In this manner, the data-broadcast stream for content selection, which is sent to the 1394 bus 25, is received by the content display device 37 and displayed on the display device 30 by the screen-displaying part 5. The user selects a content to be moved, by referring to the screen for content selection, which is displayed on the display device 30. In this case, content selection is performed not by the content display device 37 but by the content-selecting part 2. That is, the screen-displaying part 5 has a function only for displaying a screen for selection, which has been received via the 1394 bus 25, while all the content selection process and display of the thus selected screens are performed by the content-selecting part 2. In this manner, a content to be moved is selected.

On the other hand, the move-process controlling part 301 sends a process instruction 302 to the destination-designating part 3. A screen for operation (destination selection) generated by the destination-designating part 3 is displayed on the display device 30 in the same course as the case of the above-mentioned screen for content selection. The user designates the destination, by referring to the screen for the destination designation, which is displayed on the display device 30. Similarly to the above example of the content selection, designation of destination is performed not by the content display device 37 but by the destination-designating part 3. In this manner, the destination is designated.

As mentioned above, content selection and destination designation are completed. Then, the move-process controlling part 301 notifies the process instruction 302 to the send-controlling part 9 in order to send the content to a predetermined destination. Receiving the process instruction 302, the send-controlling part 9 sends a move-operation controlling notification 24 to the content-managing part 6. Receiving the move-operation controlling notification 24, the content-managing part 6 selects a corresponding content from the storing part 1, and receives it as an original stream 22, and sends it to the send-controlling part 9 as a processed stream that is encrypted for example to be sent to the content-recording apparatus 31. The send-controlling part 9 sends the processed stream 23 to the 1394 bus 25, and delivers it to the content-recording apparatus 31. At this time, operations for deleting the content and for restricting the destination are performed at the content-managing part 6 and the send-controlling part 9. Details thereof have been described in the previous embodiments, and thus the explanation here will be omitted.

Detecting that the corresponding content is moved to the content-recording apparatus 31, the move-process controlling part 301 notifies the process instruction 302 to a move-end notifying part 300. The move-end notifying part 300 generates a data-broadcast stream for displaying, on the display device 30, a screen for notifying the user that the move-process is completed, and sends it to the content display device 37 in the same course as the screen for content selection as mentioned above.

This embodiment is advantageous in that a conventional and commercially available apparatus can be used for the apparatuses other than the content-sending apparatus 36. For example, a BS digital broadcast receiver for domestic use can be used for the content display device 37, and a D-VHS recorder can be used for the content-recording apparatus 31. As indicated in this embodiment, by providing a function of generating an operation screen or a notification screen by using the data-broadcast generating part 15 and transmitting the screen as a data-broadcast stream 303, a move-process can be realized with a system including conventional apparatuses as the components.

The configuration of this embodiment is advantageous in that conventional apparatuses can be applied, but it also has the following problem. In this system, the data-broadcast stream 303 cannot be sent to the content display device 37 during a period for performing the content-move process. The reason is that, when the content-sending apparatus 36 has only one send-controlling part 9, only one stream can be sent to the 1394 bus 25. As a result, the user cannot know the progress of the content-move-process partway through the process.

The following two measures can be taken for solving such a problem. A first measure is to display on the display device 30 a screen for notifying a move-end, at the time point that the move-process is ended, as mentioned above. By applying this measure, the user can acknowledge completion of the move process. A second measure is to arrange a move-state displaying part 304 as shown in FIG. 11. The move-state displaying part 304 receives a move-state notification 305 from the content-managing part 6, and based on this, displays the state visually to the user. A specific example of the move-state display part 304 is a special displaying part such as LED that displays the progress of the move process as a percentage.

As described above, the content move system according to this embodiment enables to move a content with managed copyright, using a general digital broadcast receiver or a digital broadcast video-recorder that have been on the market.

### Fourth Embodiment

A fourth embodiment of the present invention will be described below.

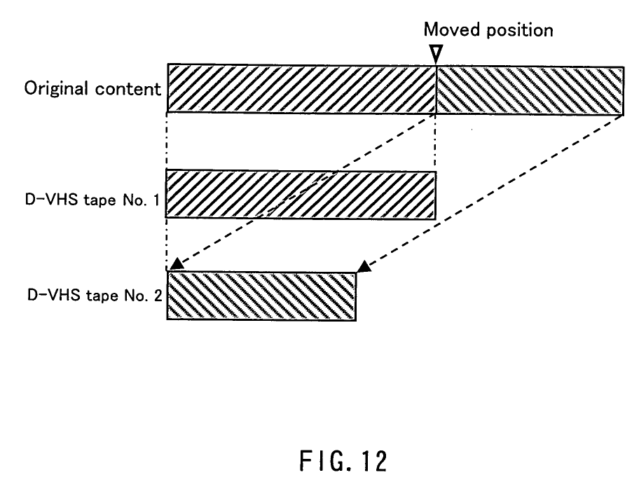

First, regarding a conventional content move system, operations for a case where a content to be moved is divided and recorded on at least two recording media and problems for the case are described by referring to FIG. 12.

FIG. 12 shows schematically an example of dividing a content to be moved and retaining the content in two media (here, D-VHS tapes No. 1 and 2). The left edge of an original content is the reproduction-starting point of the content, and a moved position shifts to the right side over time. Since a move has been completed in an area positioned at the left of the moved position, the area is processed to be unreproducible. When a content-move is performed with respect to the D-VHS tape No. 1 for a predetermined time, the move-process is stopped due to the end of the D-VHS tape or by a stopping instruction by the user or the like. At this time, the moved position as shown in this figure is retained within the system. Next, the D-VHS tape No. 1 is exchanged to No. 2 by the user and the move process is resumed. Then, with respect to the D-VHS tape No. 2, the move process is resumed at the previously retained moved position, and the entire move-process is completed at a time of reaching the end of the original content.

In such a conventional content move system, there is a problem that video images will be dropped at an initial portion of the D-VHS tape No. 2. This dropout of the video images at the time of resuming of video recording is caused by a delay on the interface, a preparation time for the tape running system, or the like.

This embodiment aims to avoid such a dropout of video images as mentioned above and provide a content-move managing part that can continue the move without dropout of the video images even when a process for stopping the move is interposed in the halfway of the content-move.

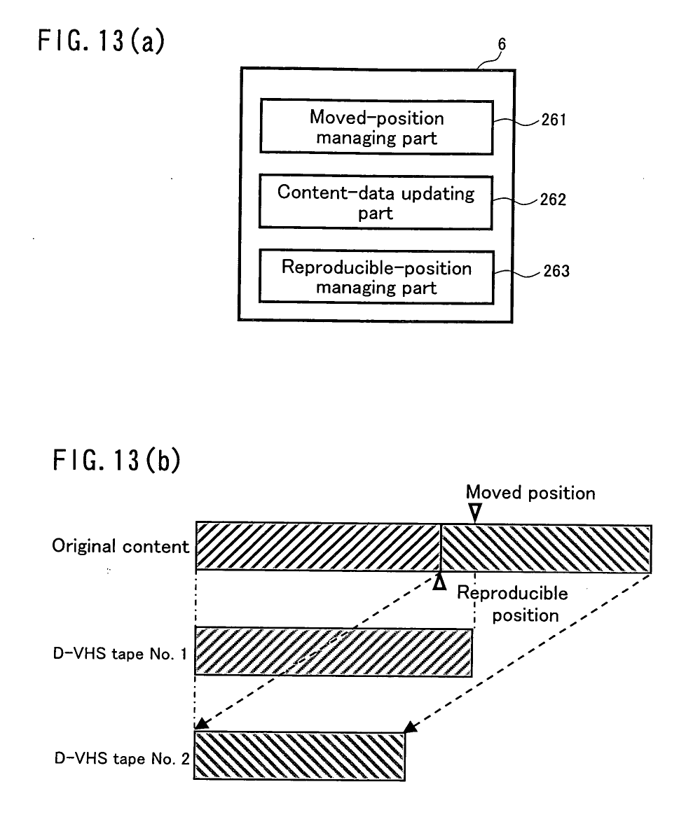

Hereinafter, by using FIGS. 13(a) and 13(b), characteristic configurations and the operation of the content move system of this embodiment will be described.

FIG. 13(a) shows an internal configuration of a content-managing part 6 according to this embodiment. FIG. 13(b) is a reference view for showing one example of a case where contents are moved to plural media in this embodiment. As shown in FIG. 13(a), the content-managing part 6 of the content move system according to this embodiment includes a moved-position managing part 261, a content-data updating part 262, and a reproducible-position managing part 263.

FIG. 13(b) shows an example of dividing a content to be moved and retaining it in two media, as in a conventional technique shown in FIG. 12. In this example, it is assumed that a portion that is included in an original content and corresponds to a predetermined time is moved to a D-VHS tape No. 1, and then moved to a D-VHS tape No. 2 continuously. At the time of starting reproduction, the left edge of the original content is initialized as a reproducible position and a moved position for the content. The moved position shifts to the right side with the progress of the move process.

This embodiment is different from conventional example in that the reproducible position is managed as well as the moved position. An area forward of the reproducible position in the content is judged as the move is completed, and processed to be unreproducible by the content-data updating part 262. As mentioned above, the DTCP specifications define that the length of a reproducible content that can be retained to overlap in the content-sending apparatus and the content-recording apparatus cannot exceed one minute, a time interval between the reproducible position and the moved position is within one minute. When a move of a content of a predetermined time period recordable on the D-VHS tape No. 1 is performed, the move process is stopped. At this time, the moved position is retained in the moved-position managing part 261, and the reproducible position is retained in the reproducible-position managing part 263.

Next, when the D-VHS tape is switched from No. 1 to No. 2 by the user and the move-process is resumed, the move-process for the D-VHS tape No. 2 is resumed at the reproducible position that has been retained, and the move is completed at a time point that it reaches the end of the original content. By managing the two positions of the reproducible position and the moved position at the time of the move operation in the above-mentioned process, an area as so-called ‘margin’ can be generated. Thereby, when dividing a content into plural media, the content can be moved without any dropout of the video images at the connection point.

For generating the ‘margin’ as shown in FIG. 13(b), the reproducible position and the moved position must be set differently from each other corresponding to the following conditions. A first condition is for the first move of the content, a second condition is for a case where the move is suspended during the move operation, and a third condition is for a case where the move is completed. Furthermore, the second condition is classified into the following two conditions. First, a condition 2-1 is for a case where the move operation is stopped forward of the previously moved position, and a condition 2-2 is for a case where the move operation is stopped in the rear of the previously moved position.

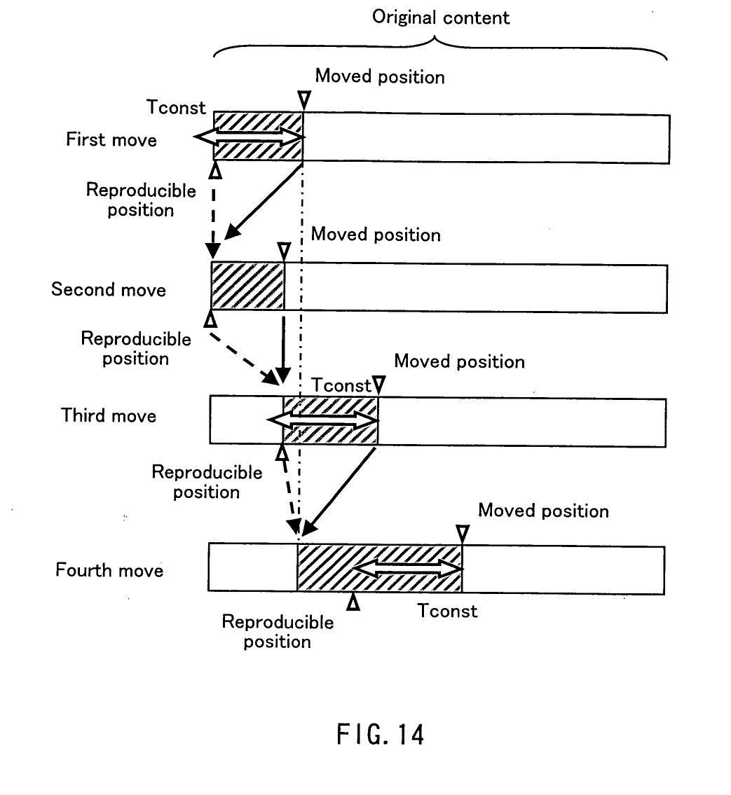

FIG. 14 shows an example of setting the reproducible position and the moved position in a case where one content (original content) to be moved is subjected to repeated cycles of move, suspension and resumption. In this example, a second move process is stopped at a position forward of a position moved due to a first move. In this figure, a dotted arrow indicates an initially set value for a reproducible position for each cycle, and the solid arrow indicates an initially set value for a moved position for each cycle. The upward triangle indicates a reproducible position at the time of move-end for each cycle, and the downward triangle indicates a moved position at the time of move-end for each cycle. In FIG. 14, the left edge corresponds to a starting position of the original content, and the right edge corresponds to an ending position of the original content.

The following description with a reference to the highest stage in FIG. 14 is about a method of setting a reproducible position and a moved position at the time of a first move regarding the first condition. A steady difference between the reproducible position and the moved position during a move is denoted as Tconst. The Tconst is defined as a constant value within one minute according to the DTCP specifications. First, in a preparation stage prior to a start of the move process, a reproducible position and a program-starting position are set at a program-starting position of the original content (the left edge of the original content shown in FIG. 14). After starting a move, with the progress of the move process, the moved position moves to the right side every moment. However, the reproducible position is not moved until a distance from the reproducible position to the moved position exceeds Tconst. When the distance from the reproducible position to the moved position reaches Tconst, the reproducible position moves to the right side every moment while the distance from the moved position is kept at Tconst. When the move process is continued while keeping this state, the shift is carried out with a relationship of Tconst=(moved position)−(reproducible position). In the first move process shown in the highest stage in FIG. 14, the distance from the reproducible position (starting position of the original content) to the moved position is smaller than Tconst.

The second stage in the same figure indicates a method of setting for the case of the above-mentioned condition 2-1. As mentioned above, in the first move process as shown in the highest stage in FIG. 14, the move process is stopped before the distance of the moved position from the reproducible position reaches Tconst. In this case, the second move process is started at the head of the original content, as in the first move process. FIG. 14 shows a case where the second content-move is stopped before reaching the first moved position. If such a process is carried out, plural moves in the same portion of the original content would be available, and thus the primary object of the move process might not be achieved.

Therefore, in this embodiment, in a case where it is acknowledged that the second move process is ended forward of the previously-moved position, the reproducible position and the moved position are set avoiding the moved-portion when the next move is started, as shown in the third stage in the same figure. That is, at the time of the third move of the content, by judgment based on a result of the state of the second move, both the reproducible position and the moved position are set to the second moved position. This serves to prevent the same portion of the content from moving more than twice.

In the third stage in FIG. 14, as mentioned above, the move starts in a state where the reproducible position and the moved position are set at the same position (the second moved position). In the third stage, with the progress of the move process, the moved position moves to the right side, while the reproducible position is not moved until the distance between the moved position and the reproducible position reaches Tconst, just like the case of the first content-move. Similarly, the move process in the third stage of FIG. 14 is ended before the distance between the moved position and the reproducible position reaches Tconst.

As shown in a fourth stage of FIG. 14, at the time of starting a fourth move, the last position, which is among already-moved positions and separated by not more than Tconst from the moved position in the third move process, is set as the initial value for the reproducible position and the moved position. That is, the fourth stage of FIG. 14 corresponds to the above-mentioned condition 2-2. From this state, the moved position shifts to the right side each moment, with the progress of the move process. The reproducible position is not moved until the distance from the moved position reaches Tconst, but after the distance from the moved position reaches Tconst, it shifts to the right side together with the moved position so as to keep the distance from the moved position to Tconst.

In the example shown in FIG. 14, a method of resetting the moved position to the previous reproducible position at the start of the second move is applied. Alternatively, the moved position can be retained at the previously-moved position. In this case, however, if a move in the later move process is stopped in a period shorter than Tconst, a portion that functions as ‘margin’ will not exist.

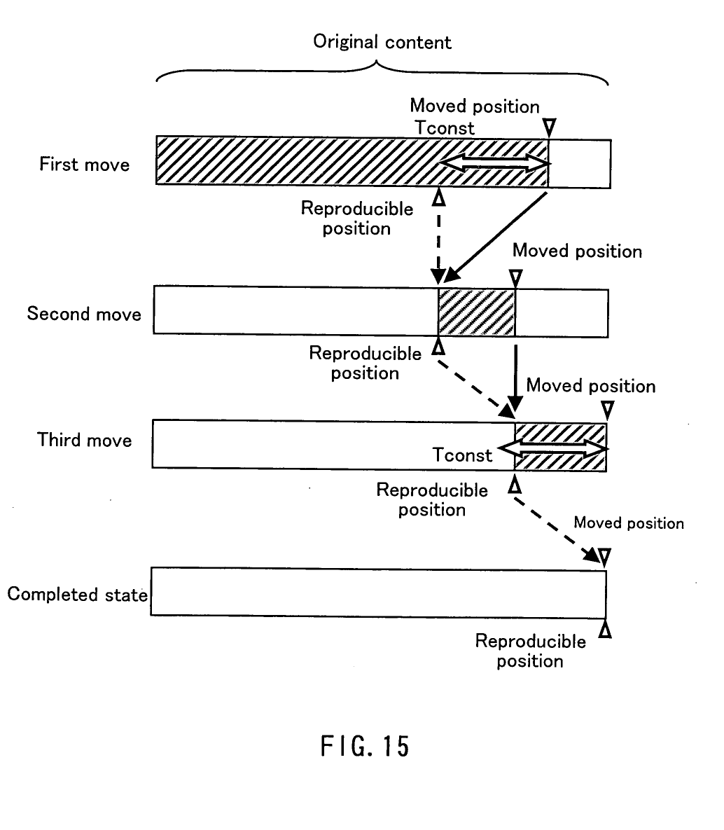

Similarly to FIG. 14, FIG. 15 shows an example for a case where the second move process is stopped forward of the first moved position. FIG. 15 shows an example of setting the reproducible position and the moved position under the above-mentioned third condition. In FIG. 15, operations for setting the reproducible position and the moved position regarding from the first content-move to the third content-move are the same as those shown in FIG. 14, and thus the explanation will be omitted. In FIG. 15, the bottom stage shows a position designation at the time that the move is completed. As shown in FIG. 15, in a case where the moved position reaches the final of the content due to the third content-move, if the reproducible position still is set at the position indicated with the upward triangle in the third stage of FIG. 15, a re-move from the position to the content end will be available. Therefore, in this embodiment, in a case where the moved position reaches the content end, the reproducible position also is moved to the final of the content. In this manner, when a move to the end of the content is ended, the reproducible position is set at the end of the content so that a further reproduction of the content will be impossible. Thereby, the end portion of the content is prevented from moving many times.

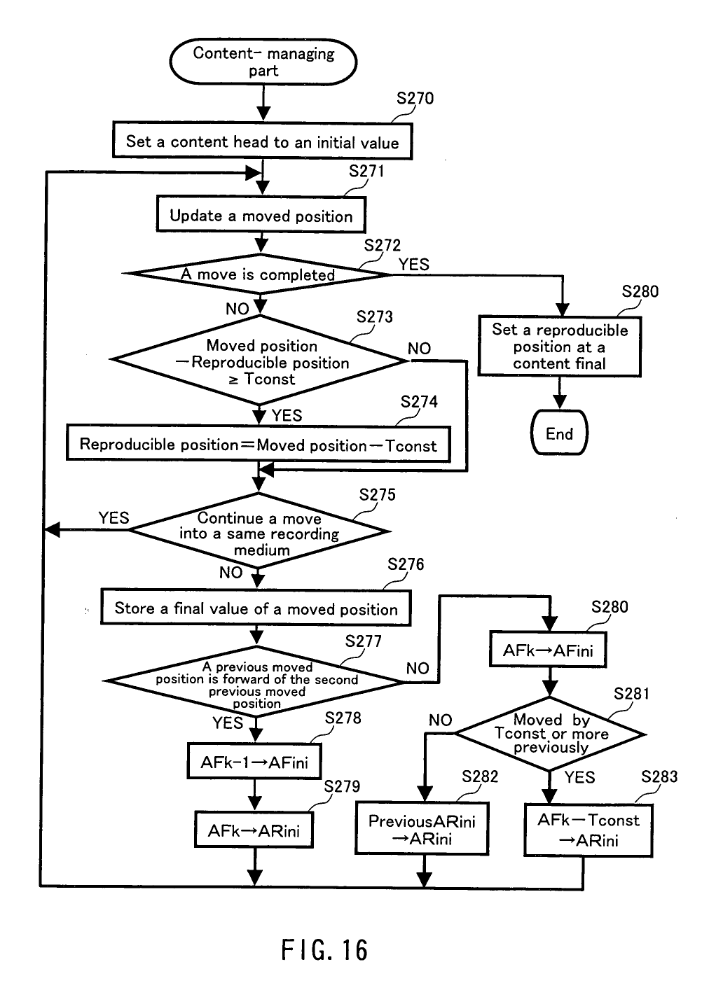

FIG. 16 is a flow chart for showing procedures for management of a reproducible position and a moved position by the content-managing part 6 in this embodiment, in a case where one content is divided and recorded on plural recording media.

As shown in FIG. 16, when starting a content-move to a first recording medium, the moved-position managing part 261 and the reproducible-position managing part 263 retain, in an internal memory (not shown), the head address of the content to be moved, as an initial value (AFini) of a moved position AF and an initial value (ARini) of a reproducible position AR (S270). And with the progress of the content-move process, the moved-position managing part 261 updates the value of the moved position AF retained in the memory (S271).

When the moved position AF is updated, the moved-position managing part 261 judges (S272) whether the moved position AF after the updating reaches the end of the content. In a case where the judgment of the step S272 is YES (a case where the above-mentioned third condition is established), the reproducible-position managing part 263 sets the reproducible position at the final of the content (S280), and completes the content-move operation.

When the judgment in the step S272 is NO, the moved-position managing part 261 judges (S273) whether a difference between the value of the updated AF value and the reproducible position AR value exceeds Tconst. In a case where the judgment of the step S273 is YES, the reproducible-position managing part 263 updates the value of the reproducible position AR to a value obtained by subtracting Tconst from the value of AF representing a moved position (S274). In a case where the judgment in the step S273 is NO, the step S274 is skipped to proceed to a step S275.

In the step S275, a judgment is made about whether a content-move to the same recording medium is continued. When the judgment in the step S275 is YES, the process returns to the step S271 so as to repeat the processes of the steps S271 to S274. When the judgment in the step S275 is NO, the moved-position managing part 261 stores the final value of the moved position AF for this move process in the internal memory (S276). Here, this move-process is the content-move process onto a k^{th}-order recording medium, and the final value of the moved position AF in the move-process is stored as AFₖ. Later, for example, after the user exchanges the recording medium to a (k+1)^{th}-order recording medium, a content-move operation is resumed.

Here, before resuming the content-move to a new recording medium, the moved-position managing part 261 judges (S277) whether the final value (AFₖ) of the moved position due to the previous move-process recorded in the internal memory is closer to the head of the content than the final value (AFₖ₋₁) of the moved position due to the second previous move-process.

When the judgment in the step S277 is YES (i.e., the above-mentioned condition 2-1 is established), the moved-position managing part 261 sets the final value (AFₖ₋₁) of the moved position in the second previous move-process to the initial value AFini of the moved position in the present move process (S278), and the reproducible-position managing part 263 sets the final value (AFₖ) of the moved position by the previous move process as an initial value ARini of a reproducible position (S279). And a content-move operation to a new recording medium is resumed (return to the step S271).

When the judgment in the step S277 is NO (i.e., the above-mentioned condition 2-2 is established), the moved-position managing part 261 sets the final value (AFₖ) of the moved position in the previous move-process, as an initial value AFini of the moved position in the present move-process (S280). Next, it judges (S281) whether the amount of the previous move-process is equal to or larger than Tconst. When the judgment in the step S281 is NO, the reproducible-position managing part 263 sets the initial value ARini of the reproducible position at the time of the previous move-process as an initial value ARini for the present reproducible position (S282). When the judgment in the step S281 is YES, a value obtained by subtracting Tconst from the final value (AFₖ) of the position moved due to the previous move-process is set as an initial value ARini of the present reproducible position (S283). And a content-move operation to a new recording medium is resumed (return to step S271).

As mentioned above, in the content move system according to this embodiment, when a content is divided and moved to plural recording media, a head of a second or latter recording medium is provided with a portion (i.e., ‘margin’) generated to overlap with the last portion of the content recorded in the former recording medium, thereby preventing dropout of video images.

The content move system according to this embodiment is characterized in the configuration and operations of a content-managing part for generating a ‘margin’ in a case of dividing and recording the content on plural recording media. Therefore, the system can be provided as a system to move the content from a content-sending apparatus to a content-recording apparatus as described in the previous embodiments. However, the content-sending side and the content-recording side need not necessarily exist as independent apparatuses. For example, in a device such as an optical disc recorder including a hard disc, in a case of moving a content that has been stored in the hard disc, a method of managing the reproducible position and the moved position according to this embodiment can be applied.

In every embodiment as mentioned above, an IEEE1394 bus was described as one example of an external bus. The bus used in the present invention is not limited to this example, but any arbitrary bus can be used as long as it can realize the content-move.

The present invention is available also as a content move system for moving a content recorded on a hard disc device or the like to other recording media such as an optical disc.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, all changes that come within the meaning and range of equivalency of the claims are intended to be embraced therein.

1. A content move system for moving a content recorded on a first recording medium to a second recording medium, the content move system comprising:
a content-sending apparatus for reading a content from the first recording medium,
a content-recording apparatus for recording the content on the second recording medium, and
a content-move controller for controlling a content-move operation conducted by the content-sending apparatus and the content-recording apparatus,
the content-sending apparatus, the content-recording apparatus and the content-move controller are connected onto a same bus; wherein
the content-move controller comprises a move-source controlling part for managing the operation of the content-sending apparatus and a destination-controlling part for managing the operation of the content-recording apparatus;
the content-sending apparatus comprises a content-managing part for reading a content to be moved from the first recording medium and updating the stream information of the content so as to be sent to the bus, and a controller-monitoring part for monitoring the operation of the content-move controller.

2. The content move system according to claim 1, wherein the content-sending apparatus further comprises a destination-restricting part that passes a decryption key of the content to only an apparatus designated as a content-recording apparatus, thereby performing a destination-restricting process of restricting the content destination to the content-recording apparatus.

3. The content move system according to claim 1, wherein the move-source controlling part detects an operation state of the content-sending apparatus at the time of the content-move operation, and issues a record-ending request to the destination-controlling part when an abnormality in the operation state is detected; and
the destination-controlling part detects an operation state of the content-recording apparatus at the time of the content-move operation, and issues a move-ending request to the move-source controlling part when an abnormality in the operation state is detected.

4. The content move system according to claim 1, wherein the controller-monitoring part issues a command for inquiring the operation state of the content-move controller, to the content-move controller.

5. The content move system according to claim 4, wherein the controller-monitoring part issues the command at a time interval of not longer than one minute.

6. The content move system according to claim 1, wherein the controller-monitoring part detects the operation state of the content-move controller, on the basis of whether a command access from the content-move controller to the content-sending apparatus is performed at a predetermined cycle.

7. The content move system according to claim 6, wherein the predetermined cycle is an interval of not longer than one minute.

8. The content move system according to claim 1, wherein the controller-monitoring part comprises a command-execution limiting part for executing only a command that agrees with a particular condition, and rejects commands except a command from the content-move controller during the content-move operation.

9. The content move system according to claim 8, wherein the controller-monitoring part comprises an apparatus-list acquiring part for acquiring information about connected apparatuses on the bus when bus initialization occurs during the content-move operation, and after the bus initialization, the controller-monitoring part executes a command only from the content-source controller in a case where the controller-monitoring part confirms that the content-move controller exists on the bus, on the basis of the connected apparatuses information acquired by the apparatus-list acquiring part.

10. The content move system according to claim 2, wherein the content-sending apparatus comprises a progress-notifying part for notifying the progress state of the destination-restricting process by the destination-restricting part, to the content-move controller.

11. The content move system according to claim 2, wherein the content-sending apparatus comprises a bus-monitoring part that suspends the content-move operation in the case where bus initialization occurs continuously after the destination-restricting process by the destination-restricting part is completed.

12. The content move system according to claim 11, wherein the time that the bus initialization-monitoring part requires for suspending the content-move operation from the first bus initialization operation among the continuous bus initialization operations is not longer than one minute.

13. The content move system according to claim 1, wherein the content-sending apparatus comprises a second destination-controlling part for managing the content-recording apparatus; and
when detecting an operation abnormality in the content-move controller during the content-move operation, the controller-monitoring part activates the second destination-controlling part so as to perform the content-move operation continuously.

14. The content move system according to claim 1, wherein the content-move controller is packaged in a same hardware as the content-recording apparatus.

15. A content move system for moving a content recorded on a first recording medium to a second recording medium, the content move system comprising:
a content-sending apparatus for reading a content from the first recording medium, and
a content-recording apparatus for recording the content on the second recording medium
the content-sending apparatus and the content-recording apparatus are connected onto a same bus; wherein
the content-sending apparatus comprises a content-managing part for reading a content to be moved from the first recording medium and updating the stream information of the content so as to be sent to the bus, and a data-broadcast generating part for changing information other than the content sent from the content-managing part into a data-broadcast stream and sending to the bus.

16. The content move system according to claim 15, wherein the content-sending apparatus comprises a move-state displaying part for displaying a partway state of the content-move by the content-managing part.

17. A content move system for moving a content recorded on a first recording medium to a second recording medium, the content move system comprising:
a content-sending apparatus for reading a content from the first recording medium, and
a content-recording apparatus for recording the content on the second recording medium,
the content-sending apparatus and the content-recording apparatus are connected onto a same bus; wherein
the content-sending apparatus comprises a content-managing part for reading a content to be moved from the first recording medium and updating the stream information of the content so as to be sent to the bus;
the content-managing part comprises a position-managing part for managing a moved position and a reproducible position in the content, and when the move operation is suspended, the content-managing part sets, as a reproducible position, a position dated back toward the head of the content from the moved position for a predetermined time, and resumes the move operation at the reproducible position.

18. The content move system according to claim 17, wherein a difference between the moved position and the reproducible position is not longer than one minute in terms of a normal reproduction time.

19. A content-sending apparatus comprising a first recording medium for recording a content and moves the content to a second recording medium provided in a content-recording apparatus connected via a bus, wherein
the content-sending apparatus is connected via the bus also to a content-move controller for controlling the content-move operation; and
the content-sending apparatus comprises a content-managing part for reading a content to be moved from the first recording medium and updating the stream information of the content so as to be sent to the bus, and a controller-monitoring part for monitoring the operation of the content-move controller.

20. A content-sending apparatus comprising a first recording medium for recording a content and moves the content to a second recording medium provided in the content-recording apparatus connected via a bus, wherein
the content-sending apparatus comprises a content-managing part for reading a content to be moved from the first recording medium and updating the stream information of the content so as to be sent to the bus, and a data-broadcast generating part for changing information other than the content sent from the content-managing part into a data-broadcast stream and sending to the bus.

21. A content-sending apparatus comprising a first recording medium for recording a content and moves the content to a second recording medium provided in a content-recording apparatus connected via a bus, wherein
the content-sending apparatus comprises a content-managing part for reading a content to be moved from the first recording medium and updating the stream information of the content so as to be sent to the bus; and
the content-managing part comprises a position-managing part for managing a moved position and a reproducible position in the content, and in a case of suspending the move operation, the content-managing part sets, as a reproducible position, a position dating back toward the head of the content from the moved position for a predetermined time, and resumes the move operation at the reproducible position.
